(19) United States
(12) Patent Application Publication
(10) Pub. No.: US 2014/0251112 A1
(43) Pub. Date: Sep. 11, 2014

(54) TREMOLO ARM COUPLING STRUCTURE FOR TREMOLO BRIDGE

(71) Applicant: TAESUNG PRECISION CO., LTD., Incheon (KR)

(72) Inventor: Sung Woo KANG, Incheon (KR)

(73) Assignee: TAESUNG PRECISION CO., LTD., Incheon (KR)

(21) Appl. No.: 13/845,091

(22) Filed: Mar. 18, 2013

(30) Foreign Application Priority Data
Mar. 5, 2013 (KR) 10-2013-0023165

(51) Int. Cl. G10D 3/14

(52) U.S. Cl. CPC G10D 3/146
USPC 84/313

(57) ABSTRACT

There is disclosed a tremolo arm coupling structure for a tremolo bridge including an arm support fixed to a tremolo bridge, an arm pressing cap coupled to the arm support, an arm pressing member inserted in the arm pressing cap, and a tremolo arm inserted in the arm pressing member, wherein the arm pressing member is compressed and coupled by tightening of the arm pressing cap.

### CROSS REFERENCE TO PRIOR APPLICATIONS

This application claims priority to Korean Patent Application No. 10-2013-0023165 filed on Mar. 5, 2013, which is hereby incorporated by reference in its entirety.

### BACKGROUND

The present invention relates to a tremolo arm coupling structure for a tremolo bridge, more particularly, to a tremolo arm coupling structure for pressing an arm pressing member so as to fasten a pressure cap having the arm pressing member inserted therein to an arm support fixed to a tremolo bridge.

Generally, an electric guitar has strings with ends fixed to a body and the other ends supported to a neck. In this state, a tuning key is used in adjusting a pulling degree of the strings so as to make a level of tension appropriate, such that the strings can make proper sounds. At this time, a tremolo bridge having a tremolo arm formed in a bar shape is provided in the body. When the tremolo arm is pressed toward the body, the tension of the string coupled to the tremolo bridge is loose enough to lower a note. In other words, a guitar player uses the tremolo arm when trying to play a low tone suddenly during the playing an electric guitar.

Such a tremolo arm is proposed in Korean Patent No. 2000-0022757 disclosing a tremolo arm coupled to a tremolo bridge by a pin or with rotating the tremolo arm. This disclosure has a disadvantage that a tremolo arm might be loose, by extension, separated from a tremolo bridge when the tremolo arm is coupled to the tremolo bridge with rotating the tremolo arm or by the coupling pin. In addition, there is another disadvantage that the coupling state between the tremolo arm and the tremolo bridge might be loose by deformation of the coupled portion when the tremolo arm is used for a long time.

Meanwhile, to overcome such disadvantages, Korean Patent Registration No. 1075400 (2011. October 14) proposing a tremolo arm coupling device for a tremolo bridge that has an inner fastening part inserted in a arm coupling part by an arm pressing part coupled to the coupling part integrally formed with the tremolo bridge, with a female screw part formed therein, the inner fastening part pressedly coupled to a surface of the tremolo arm. However, when the tremolo arm coupling device disclosed in Korean Patent Registration No. 1075400 is used for a long time, the arm pressing part and the inner fastening part are separated and might be lost.

Moreover, the complex structure of the arm pressing part and the inner fastening part results in a long time of the fabrication process and a low productivity, such that the price might be heightened disadvantageously.

### SUMMARY OF THE INVENTION

To solve those disadvantages, an object of the invention is to provide a tremolo arm coupling structure configured to couple a tremolo arm to a tremolo bridge pressingly and smoothly such that loss of the tremolo arm may be prevented to use the tremolo arm for a long time and that components may be reduced, with a simple structure.

To achieve these objects and other advantages and in accordance with the purpose of the embodiments, as embodied and broadly described herein, a tremolo arm coupling structure for a tremolo bridge includes an arm support fixed to a tremolo bridge; an arm pressing cap coupled to the arm support; an arm pressing member inserted in the arm pressing cap; and a tremolo arm inserted in the arm pressing member, wherein the arm pressing member is compressed and coupled by tightening of the arm pressing cap.

The arm support may include a supporting body, a male screw formed in a predetermined portion of the supporting body and an embedded portion formed in the other portion of the supporting body, corresponding to the male screw, and a hooking protrusion formed between the male screw and the embedded portion, and the arm pressing cap may include a pressing cap body, an arm pressing member inserting groove enlargedly formed in an inner circumferential surface thereof, an arm inserting hole formed in an end of the pressing cap body, a screw fastening portion formed in the other end of the pressing cap body, with a female screw, and the female screw may be fastened to the male screw.

The arm pressing member may be formed of urethane, with a penetrating hole formed therein.

The arm pressing member may be formed of silicon, with a penetrating hole formed therein.

The arm pressing member may include a tapered guide portion formed in an entrance of the penetrating hole.

The tremolo arm may include a pressing force maximizing portion formed in an outer circumferential surface thereof that is inserted in the arm pressing member.

The pressing force maximizing portion of the tremolo arm may be a convex semicircular groove.

The pressing force maximizing portion of the tremolo arm may be a convex right-angled triangle groove.

The fixing portion of the tremolo arm may be bent in an end of a handle at a right angle and a tapered insertion guide may be integrally formed in an end of the fixing portion.

The embodiments have following advantageous effects. The pressing cap having the arm pressing member inserted therein is fastened to the arm support fixed to the tremolo bridge. In this process, the arm pressing member is insertedly pressed. Accordingly, the compressed state of the tremolo arm can be maintained effectively.

Furthermore, the loss of the tremolo arm may be prevented and the tremolo arm can be used for a relatively long time.

Still further, the components composing the tremolo arm coupling structure can be reduced and the structure can be simplified.

Therefore, productivity may be enhanced and the price can be lowered.

### BRIEF DESCRIPTION OF THE DRAWINGS

FIG. 1 is a front view of an electric guitar having a tremolo arm coupling structure for a tremolo bridge according to the present invention;

FIG. 2 is a perspective diagram of a tremolo bridge having the tremolo arm coupling structure according to the present invention;

FIG. 3 is a perspective diagram of the tremolo arm coupling structure cut away from the tremolo bridge according to the present invention;

FIG. 4 is a perspective diagram of inner and outer parts cut away from the tremolo arm coupling structure according to the present invention;

FIG. 5 is a sectional diagram of the inner part cut away from the tremolo arm coupling structure according to the present invention; and

FIGS. 6A and 6B are sectional diagrams illustrating coupling states of the tremolo arm coupling structure according to the present invention.

### DETAILED DESCRIPTION OF THE INVENTION

An exemplary embodiment will be described as follows, referring to the accompanying drawings.

A tremolo arm coupling structure for a tremolo bridge according to the present invention includes a tremolo bridge 10 and a tremolo arm 50 coupled to the tremolo bridge 10. An electric guitar having the tremolo bridge 10 coupled thereto includes a body 60 occupying a large part of the guitar. A neck 61 is formed in the body 60 and the neck 61 has a head having a tuning key connected to an end thereof. Strings 62 are fixedly wound around the head from the tremolo bridge 10 to tune the guitar. At this time, a nut is provided between the head of the neck 61 and a fingerboard to make a predetermined space for preventing the strings 62 from being stuck together such that a predetermined tension may be generated. In addition, the nut may make the strings not interfere with each other like the tremolo bridge 10 of the body 60.

Flats configured of iron cores makes notes sound precisely and the body 60 includes the tremolo bridge 10 for fixing the strings 62, such that a predetermined space may be formed between the body 60 and the strings 62. In addition there may be provided a peak guard, a sound hole, a tail piece and an end pin.

The electric guitar creates a note when the player picks or plucks the strings 62 and vibration is generated in the body 60 by the strings 62 connected to the body 60 and the neck 61, to sound notes.

When the tuning key provided in the head is adjusted, the strings 62 are pulled toward the neck 61 from the tremolo bridge 10 to tune the guitar. The tremolo arm 50 is configured to tune the tension of the strings 62 and the arm 50 is pressed toward the body 60, especially, the neck 61 during the playing the guitar, to press the body 60.

Once the tremolo arm 50 is pressed toward the body 60, a back side of the tremolo bridge 10 is lifted and a string 62 having an end fixed to the tremolo bridge 10 is loose to lower a note.

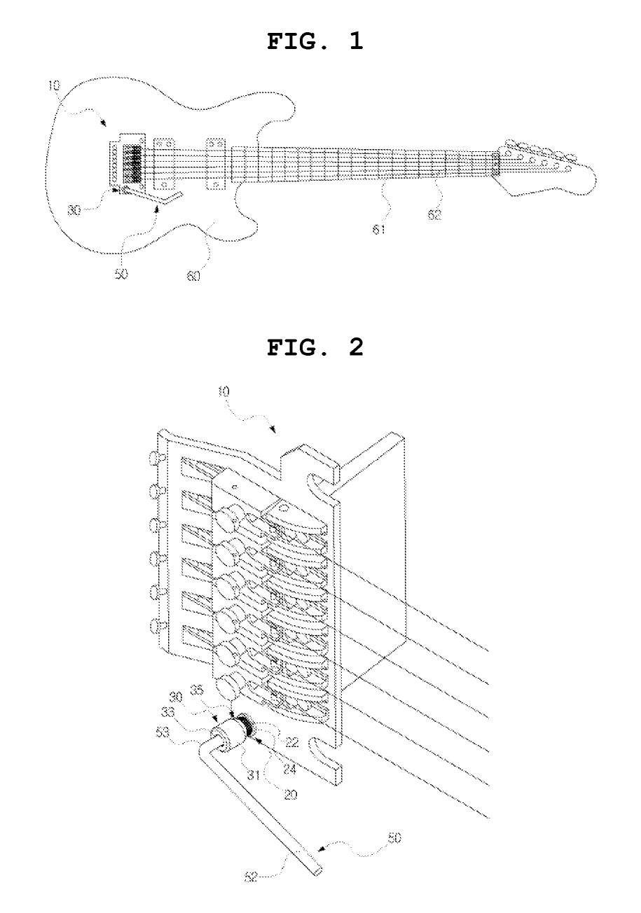

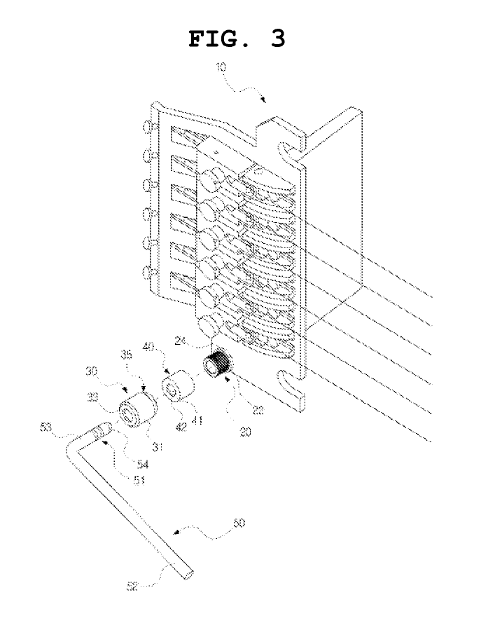

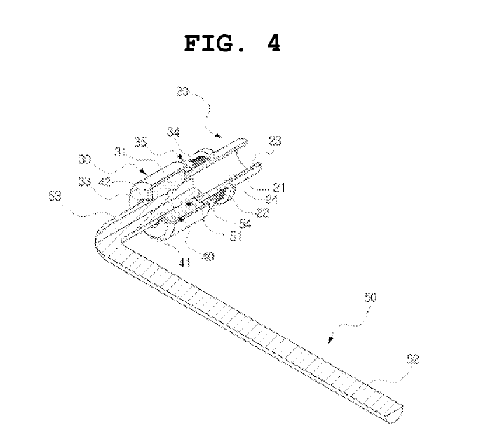

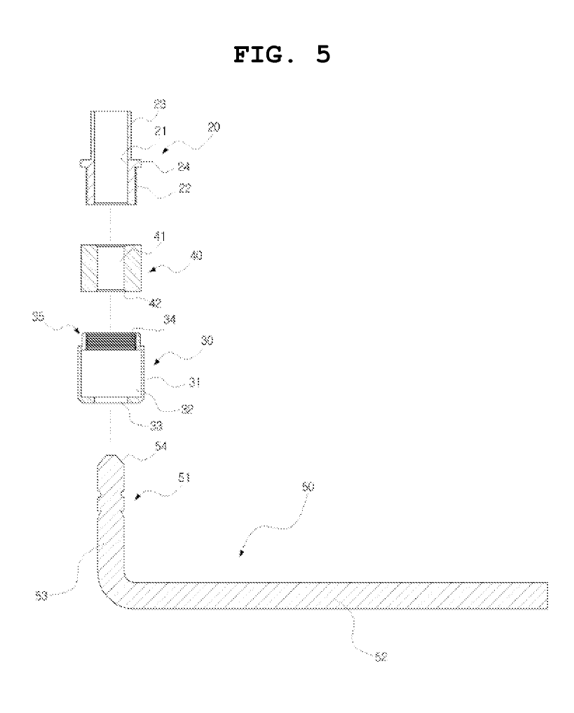

An arm coupling structure for such the tremolo bridge may be configured of the tremolo bridge 10, an arm support 20, an arm pressing cap 30, an arm pressing member 40 and a tremolo arm 50, as shown in FIGS. 1 through 5. The arm support 20 is fixed to the tremolo bridge 10 and the arm pressing cap 30 is coupled to the arm support 20.

The arm pressing member 40 is inserted in the arm pressing cap 30 and the tremolo arm 50 is inserted in the arm pressing member 40, such that the arm pressing member 40 may be coupled to the arm pressing cap 30 when the arm pressing cap 30 is tightened up.

In this instance, the arm support 20 includes a male screw 22 formed in a predetermined portion of the support body 21 formed in a hollow shape. An embedded portion 23 is integrally formed with the other portion of the support body 21, corresponding to the male screw 22.

A hooking protrusion 24 is formed between the male screw 22 and the embedded portion 23, to prevent the arm support 20 from being embedded more than a predetermined limit.

The arm pressing cap 30 may prevent separation of the arm pressing member 40 and support a function of tightening the arm pressing member 40 to be narrow inwardly. An arm inserting hole 33 is formed in an end of a pressing cap body 31 having an arm pressing member inserting groove 32 enlargedly formed in an inner circumferential surface thereof. A screw fastening portion 35 having a female screw 34 is integrally formed in the other end of the pressing cap body 31, to fasten the female screw 34 to the male screw 22.

The arm pressing member 40 has a hollow shape and it is flexibly deformed by a pressing force. As soon as the pressing force is removed, the arm pressing member 40 may restitute.

The arm pressing member 40 has a penetrating hole 41 having the same diameter or a larger diameter as or than a diameter of the tremolo arm 50. Also, the arm pressing member 40 may be formed of urethane.

The arm pressing member 40 further includes a guide portion 42 tapered in an entrance of the penetrating hole 41, such that a front end of a fixing portion 53 provided in the tremolo arm 50, which will be described later, may be inserted in the penetrating hole smoothly.

In the present invention, it is proposed that the arm pressing member 40 is formed of urethane to be deformed efficiently. However, rather than the urethane, it is preferable that the arm pressing member 40 is formed of silicon with the same type of the penetrating hole 41.

The tremolo arm 50 includes a pressing force maximizing portion 51 formed in an outer circumferential surface of the tremolo arm that is inserted in the arm pressing member 40, to enhance the pressing force. The pressing force maximizing portion 51 is a semicircular groove formed along an outer circumferential surface of the fixing portion 53 in a convex type, such that a pressed portion of the arm pressing member 40 may be pressedly inserted in the semicircular groove.

According to the present invention, the pressing force maximizing portion 51 formed in the tremolo arm 50 is the convex semicircular groove formed along the outer circumferential surface of the fixing portion 53. Rather than the convex semicircular groove, it is preferred that the pressing force maximizing portion 51 is a convex right-angled triangle groove. In this instance, the inserting is performed smoothly and separation of the arm pressing member 40 may be prevented in the state where the pressed portion of the arm pressing member 40 is inserted.

The fixing part 53 is bent at an end of the handle 52 in the tremolo arm 50 at a right angle. A tapered insertion guide 54 is integrally formed at an end of the fixing portion 53, such that the tremolo arm 50 may be smoothly inserted in the arm inserting hole 33 of the arm pressing cap 30 and the penetrating hole 41 of the arm pressing member 40 without interference.

When the player cups the hand, such the arm pressing member 40 is pressed toward the penetrating hole 41 to reduce an outer diameter of the arm pressing member 40. In the state where the outer diameter is reduced, the arm pressing member 40 is inserted in the arm pressing member inserting groove 32 by the female screw 34 of the screw fastening portion 35 formed in the arm pressing cap 30 and the reduced outer diameter restitutes simultaneously.

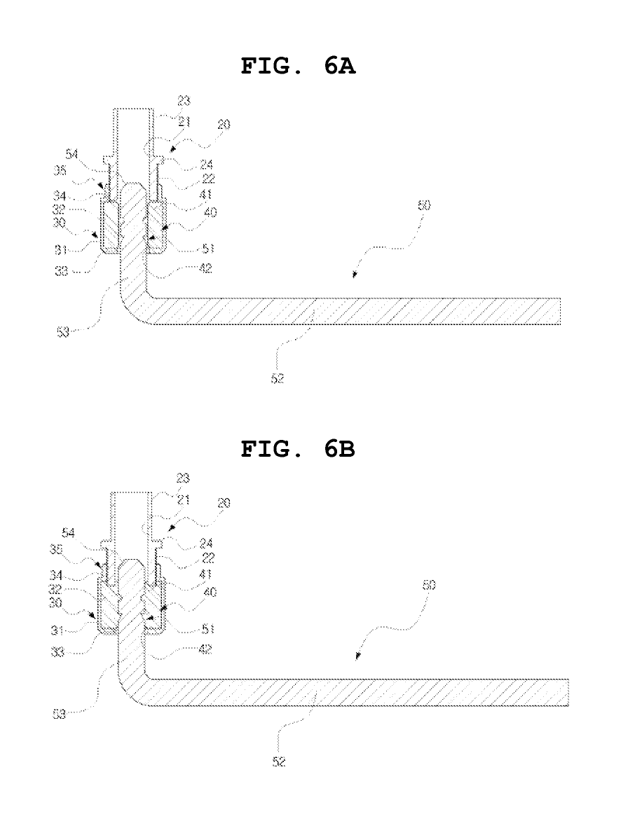

Hence, as shown in FIG. 6A, the female screw 34 of the arm pressing cap 30 engages with the male screw 22 formed in the arm support 20. After that, the fixing portion 53 of the tremolo arm 50 is inserted in the arm inserting hole 33 of the arm pressing cap 30 and the penetrating hole 41 of the arm pressing member 40.

Hence, the arm pressing cap 30 is rotated to fasten the female screw 34 to the male screw 22 and the screw fastening portion 35 is moved toward the hooking protrusion 24. At the same time, the arm pressing member 40 is moving inwardly, facing the front end of the support body 21.

Hence, as shown in FIG. 6B, the arm pressing member 40 is pressed axially by the front end of the support body 21. At the same time, the outer circumferential surface of the arm pressing member 40 is in contact with the pressing cap body 31, such that the arm pressing member may be deformed in a direction in which the penetrating hole 41 is formed. Accordingly, the arm pressing member 40 is pressed to the outer circumferential surface of the fixing portion. At this time, the arm pressing member 40 is partially inserted in the pressing force maximizing portion 51 formed in the surface of the fixing portion 53. Accordingly, the reverse direction separation of the arm pressing member 40 may be prevented.

Various variations and modifications of the femtosecond laser apparatus and the femtosecond laser system including the femtosecond laser apparatus are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A tremolo arm coupling structure for a tremolo bridge comprising:
an arm support fixed to a tremolo bridge;
an arm pressing cap coupled to the arm support;
an arm pressing member inserted in the arm pressing cap; and
a tremolo arm inserted in the arm pressing member,
wherein the arm pressing member is compressed and coupled by tightening of the arm pressing cap.

2. The tremolo arm coupling structure for the tremolo bridge according to claim 1, wherein the arm support comprises a supporting body, a male screw formed in a predetermined portion of the supporting body and an embedded portion formed in the other portion of the supporting body, corresponding to the male screw, and a hooking protrusion formed between the male screw and the embedded portion, and
the arm pressing cap comprises a pressing cap body, an arm pressing member inserting groove enlargedly formed in an inner circumferential surface thereof, an arm inserting hole formed in an end of the pressing cap body, a screw fastening portion formed in the other end of the pressing cap body, with a female screw, and
the female screw is fastened to the male screw.

3. The tremolo arm coupling structure for the tremolo bridge according to claim 1, wherein the arm pressing member is formed of urethane, with a penetrating hole formed therein.

4. The tremolo arm coupling structure for the tremolo bridge according to claim 1, wherein the arm pressing member is formed of silicon, with a penetrating hole formed therein.

5. The tremolo arm coupling structure for the tremolo bridge according to claim 3, wherein the arm pressing member comprises a tapered guide portion formed in an entrance of the penetrating hole.

6. The tremolo arm coupling structure for the tremolo bridge according to claim 1, wherein the tremolo arm comprises a pressing force maximizing portion formed in an outer circumferential surface thereof that is inserted in the arm pressing member.

7. The tremolo arm coupling structure for the tremolo bridge according to claim 6, wherein the pressing force maximizing portion of the tremolo arm is a convex semicircular groove.

8. The tremolo arm coupling structure for the tremolo bridge according to claim 6, wherein the pressing force maximizing portion of the tremolo arm is a convex right-angled triangle groove.

9. The tremolo arm coupling structure for the tremolo bridge according to claim 1, wherein the fixing portion of the tremolo arm is bent in an end of a handle at a right angle and a tapered insertion guide is integrally formed in an end of the fixing portion.

10. The tremolo arm coupling structure for the tremolo bridge according to claim 4, wherein the arm pressing member comprises a tapered guide portion formed in an entrance of the penetrating hole.
